(19) United States
(12) Patent Application Publication
(10) Pub. No.: US 2018/0066167 A1
(43) Pub. Date: Mar. 8, 2018

(54) Lightweight Carpet Products and Method of Manufacture Thereof

(71) Applicant: Beaulieu Group, LLC, Dalton, GA (US)

(72) Inventor: Robert Keith Salsman, Hoschton, GA (US)

(73) Assignee: BEAULIEU GROUP, LLC

(21) Appl. No.: 15/800,961

(22) Filed: Nov. 1, 2017

Related U.S. Application Data
(63) Continuation of application No. 13/251,609, filed on Oct. 3, 2011, now abandoned.
(60) Provisional application No. 61/389,099, filed on Oct. 1, 2010.

(51) Int. Cl. C09J 167/02; D06N 7/00; C08J 5/18; C08L 23/08

(52) U.S. Cl. CPC C09J 167/02; D06N 2205/02; D06N 2209/1628; D06N 7/0068; D06N 2203/061; C08L 23/0815; Y10T 428/23979; D06N 7/0081; C08J 5/18; D06N 2201/02

(57) ABSTRACT

A lightweight carpet product includes a greige carpet having a primary backing and tufted fibers, a secondary backing including a nonwoven textile of synthetic fibers, and a thermoplastic adhesive composition adhered to the greige carpet and the secondary backing. The thermoplastic adhesive composition includes a modified polyethylene terephthalate (PET) having a crystallinity less than unmodified PET and a melting point from about 90° C. to about 150° C., and a particulate filler. Methods of manufacture include using a thermoplastic adhesive composition to adhere a greige carpet to a secondary backing to form a lightweight carpet product.

### CROSS-REFERENCE TO RELATED APPLICATIONS

This application claims the benefit of U.S. Provisional Application No. 61/389,099, filed Oct. 1, 2010. The application is incorporated by reference herein in its entirety.

### BACKGROUND

The present disclosure relates generally to carpets and carpet tiles, and more particularly to lightweight carpet tiles and manufacturing methods.

U.S. Pat. No. 8,021,506 to Doney et al. describes using hot melt adhesive lamination for forming a carpet backing and a finished carpet or carpet tile, The hot melt adhesive may comprise a modified PET polymer, such as described in U.S. Patent Application Publication No. 2008/0236443 to Salsman, and a glass filler, such as described in U.S. Patent Application Publication No. 2006/0281851 to Salsman. These publications are incorporated herein by reference.

It is desirable in some instances to provide carpet products such as carpet tiles that have a relatively low basis weight. However, achieving this can prove difficult. For example, if the manufacturer attempts to reduce the amount of hot melt adhesive, then the finished carpet product may not hold together well and may lack durability or dimensional stability. Alternatively or in addition, the manufacturer may attempt to alter the composition of the hot melt adhesive; however, this may negatively affect the adhesive properties of the adhesive (e.g., it may not penetrate into the greige carpet), may not work with existing process equipment, and/or may undesirably increase the production costs.

It therefore would be desirable to provide improved hot melt adhesive compositions and manufacturing methods to produce relatively light weight carpet products that overcome one or more of the deficiencies associated with conventional materials and processes.

### SUMMARY

In one aspect, a lightweight carpet product, such as a carpet tile, is provided. The carpet product includes a greige carpet having a primary backing and tufted fibers, a secondary backing including a nonwoven textile of synthetic fibers, and a thermoplastic adhesive composition adhered to the greige carpet and the secondary backing. The thermoplastic adhesive composition includes a modified polyethylene terephthalate (PET) having a crystallinity less than unmodified PET and a melting point from about 90° C. to about 150° C. and a particulate filler. In certain embodiments, the carpet product has a basis weight from about 50 ounces per square yard to about 60 ounces per square yard.

In another aspect, a method of making a lightweight carpet product is provided. The method includes: (i) providing a thermoplastic adhesive composition including modified PET having a crystallinity less than unmodified PET and a melting point from about 90° C. to about 150° C., and a particulate filler; (ii) providing a greige carpet which having a primary backing and tufted fibers; (iii) providing a secondary backing including a nonwoven textile of synthetic fibers; and (iv) using the thermoplastic adhesive composition to adhere the greige carpet to the secondary backing to form a carpet product. In certain embodiments, the thermoplastic adhesive composition is dispersed onto a surface of the secondary backing to form an adhesive-loaded secondary backing and then the greige carpet is brought into contact with the adhesive-loaded secondary backing to adhere the greige carpet to the secondary backing. In certain embodiments, the method further includes applying a nip pressure to the carpet product with a press roll.

In another aspect, a method of making a thermoplastic adhesive composition is provided. The method includes transesterifying raw PET with a monomer mix to produce modified PET and non-modified PET reaction products, and removing at least a portion of the non-modified PET reaction products to produce a modified PET composition having a crystallinity less than unmodified PET and a melting point from about 90° C. to about 150° C.

### BRIEF DESCRIPTION OF THE DRAWINGS

FIG. 1 is a cross-sectional view of a lightweight carpet product, in accordance with one or more embodiments described herein.

FIG. 2 is a process diagram showing a method for manufacturing a lightweight carpet product, in accordance with one or more embodiments described herein.

### DETAILED DESCRIPTION

Improved lightweight carpet products, such as carpet tiles, have been developed, along with methods of manufacturing lightweight carpet products. The problem of providing an adhesive composition that will work in relatively reduced amounts and yet still impart sufficient durability and dimensional stability to a lightweight carpet product has been solved by providing a modified PET composition that has a crystallinity less than unmodified PET and a melting point from about 90° C. to about 150° C. with a relatively reduced amount of filler that has a high enough specific heat so that the tow viscosity adhesive composition does not cool too quickly following application to the secondary backing and/or greige carpet. In addition, the present compositions and processes overcome the difficulties with dimensional instability that otherwise occur when trying to heat the primary backing to achieve an effective penetration of the adhesive composition.

These products and methods will be described more fully hereinafter with reference to the accompanying figures, in which like numerals refer to like elements.

Carpet Products

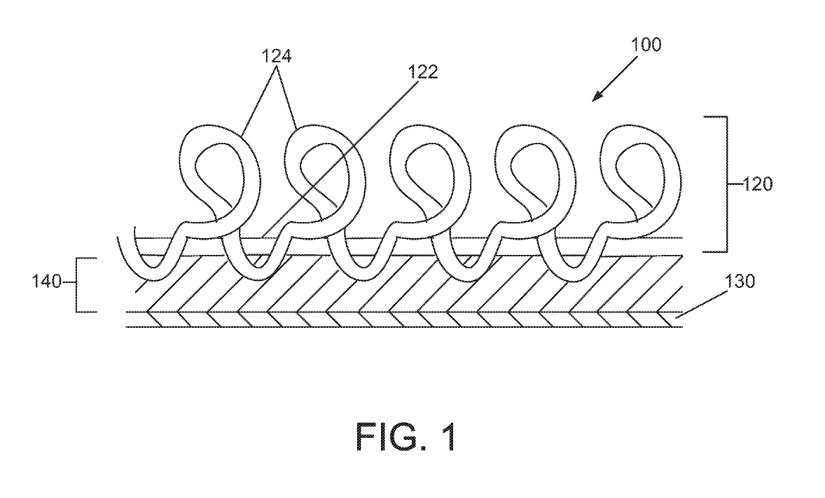

In one aspect, lightweight carpet products are provided. As shown in FIG. 1, a lightweight carpet product 100 includes a greige carpet 120, a secondary backing 130, and a thermoplastic adhesive composition 140 adhered to the greige carpet 120 and the secondary backing 130.

In certain embodiments, the greige carpet 120 includes a primary backing 122 and tufted fibers 124. For example, the tufted fibers 124 may be woven onto the primary backing 122 to form a greige carpet 120. The primary backing may be composed of nonwoven or woven polyesters, polypropylene, nylon fabrics, combinations thereof, or other suitable materials known in the art. The tufted fibers may be composed of nylon, polyester, acrylic, rayon, cotton, combinations thereof, or other suitable materials known in the art.

In certain embodiments, the secondary backing 130 is composed of a nonwoven textile of synthetic fibers. In one embodiment, the synthetic fibers are polyester fibers. For example, the secondary backing may be composed of a spunlaid nonwoven textile of polyester fibers. Other suitable synthetic fibers may include polypropylene, nylon-coated polyester fibers, or combinations thereof. The secondary backing may include single layer or multi-layer materials.

In certain embodiments, the secondary backing includes a nonwoven polyester textile having a relatively low porosity such that the thermoplastic adhesive composition will not substantially penetrate the secondary backing during manufacture. Porosity of the secondary backing ay be determined by measuring penetration of the thermoplastic adhesive composition, by measuring the flow penetration of another fluid such as air, or by measuring a light scattering effect of the material. One exemplary low porosity nonwoven polyester secondary backing material is LUTRADUR FSI 200 (commercially available from Freudenberg Nonwovens, Weinheim, Germany).

In certain embodiments, the secondary backing has a basis weight of less than 6 ounces per square yard. For example, the secondary backing may have a basis weight from about 2.5 ounces per square yard to about 6 ounces per square yard. In one embodiment, the secondary backing may have a basis weight from 3 to 5.5 ounces per square yard.

Additionally, the secondary backing material may be resistant to dimensional distortion at relatively high temperatures. For example, the secondary backing material may exhibit dimensional thermal stability at temperatures up to 350° F. As used herein, dimensional thermal stability refers to the secondary backing material shrinking less than about 5% in both the warp and weft directions at a given temperature.

The thermoplastic adhesive composition 140 penetrates the greige carpet and adheres to both the greige carpet and the secondary backing, imparting dimensional stability and durability to the final carpet product 100. In certain embodiments, the thermoplastic adhesive composition is composed of a modified polyethylene terephthalate (PET) having a crystallinity less than unmodified PET and a melting point from about 90° C. to about 150° C., and a particulate filler.

Generally, unmodified PET has a relatively high crystallinity that makes it unworkable as an adhesive in a carpet product. For example, the high crystallinity causes unmodified PET to become rigid quickly and thus does not allow to the PET to penetrate the greige carpet or adhere to the greige carpet and secondary backing. Additionally, unmodified PET does not provide the necessary flexibility for a carpet product. Therefore, a modified PET having a crystallinity less than unmodified PET is desirable.

In certain embodiments, the modified PET has a crystallinity that is a fraction of that of unmodified PET. For example, the modified PET may have a crystallinity that is at least about 10% less than the crystallinity of the unmodified PET, at least about 20% less, at least about 30% less, or at least about 50% less than the crystallinity of the unmodified PET. Crystallinity may be measured using techniques known in the art, such as differential scanning calorimetry (DSC). In one embodiment, the modified PET has a crystallinity that is between 40% and 70% of the crystallinity of unmodified PET.

In a preferred embodiment, the modified PET has a relatively low melting point. In certain embodiments, the modified PET has a melting point from about 90° C. to about 150° C. In embodiments, the modified PET composition has a melting point from about 100° C. to about 135° C., e.g., about 105° C. to about 125°C. For example, the modified PET may have a melting point from about 100° C. to about 115° C. In one embodiment, the modified PET has a relatively low melting point and a crystallinity that is between 40% and 80% of the crystallinity of unmodified PET.

The thermoplastic adhesive composition may also include a particulate filer. In certain embodiments, the particulate filler is composed of glass, ceramic, barite, calcium carbonate, magnetite, stone, or a combination thereof. In certain embodiments, the particulate filler has a particle size small than 60 mesh. For example, the particulate filler may have a particle size from about 80 mesh to about 60 mesh. In a preferred embodiment, the particulate filler comprises glass particles, such a crushed glass having a particle size from about 80 mesh to about 60 mesh.

In a preferred embodiment, the particulate filler has a relatively high specific heat that enables the filler to retain sufficient heat during the manufacture of the carpet product and thereby keep the thermoplastic adhesive composition molten. so that it may penetrate the greige carpet. In certain embodiments, this is accomplished with a particulate filler having a specific heat from about 0.15 kcal/kg° C. to about 0.25 kcal/kg° C.

The thermoplastic adhesive composition may contain a relatively low amount of filler to decrease the weight of the composition and allow an increased amount of PET to penetrate the greige carpet. It was discovered that upon compressing a secondary backing loaded with a. thermoplastic adhesive composition containing a low amount of filler and a greige carpet, a polymer-rich film penetrates into the greige carpet while a large amount of the filler remains in the adhesive layer between the greige carpet layer and the secondary backing. Therefore, a decreased amount of particulate filler may be used while maintaining the dimensional stability imparted by the filler.

In certain embodiments, the particulate filler is present in an amount less than 43 percent by weight of the thermoplastic adhesive composition. For example, the particulate filler may be present in an amount from about 37 to about 41 percent by weight of the thermoplastic adhesive composition.

The resulting thermoplastic adhesive composition may have a relatively low viscosity that allows the composition to more fully penetrate the greige carpet. In certain embodiments, the thermoplastic adhesive composition has a viscosity from about 5,000 centipoise at 325° F. to about 10,000 centipoise at 325° F. For example, the thermoplastic adhesive composition may have a viscosity from about 6,000 centipoise at 325° F. to about 8,500 centipoise at 325° F.

The thermoplastic adhesive composition may also include one or more additives to impart additional beneficial qualities to the finished carpet. For example, dyes, fire retardants, fillers, weighters, oxidization stabilizers, antibacterial agents, antimicrobial agents, antifungal agents, UV stabilizers, or combinations thereof may optionally be added to the thermoplastic adhesive composition.

The resulting carpet product 100 may be lightweight as compared to traditional carpet products. Specifically, the thermoplastic adhesive compositions described herein may display viscosity and crystallinity such that a lower amount of thermoplastic adhesive composition is sufficient to impart the desired dimensional stability and durability to the final carpet product.

In certain embodiments, a lightweight carpet product has a basis weight of less than about 60 ounces per square yard. For example, a carpet product may have a basis weight from about 50 Ounces per square yard to about 60 ounces per square yard. In one embodiment, the basis weight of the carpet product is from 52 to 58 ounces per square yard, such as about 55 ounces per square yard.

The carpet products described herein may display the necessary dimensional stability without any structural reinforcement. For example, the carpet products may not require a fiberglass mat or scrim. Rather, the thermoplastic adhesive composition and secondary backing may provide sufficient dimensional stability to the carpet product.

In certain embodiments, the carpet product displays an MT4 value of less than about 0.125 and a CT4 value of less than about 0.1, as measured according to the AACHEN test, which is standardized as ISO 2551.

In certain embodiments, the lightweight carpet product is a carpet tile. In one embodiment, a carpet tile having a basis weight from about 50 ounces per square yard to about 60 ounces per square yard includes a greige carpet, a spunlaid nonwoven polyester secondary backing, and a thermoplastic adhesive composition including a modified PET having a crystallinity less than unmodified PET and a melting point from about 90° C. to about 150° C. and a glass particulate filler in an amount from about 37 to about 41 percent by weight of the thermoplastic adhesive composition, adhered to the greige carpet and the secondary backing.

Methods

In another aspect, methods of manufacturing lightweight carpet products, such as carpet tiles, are provided. The methods include providing a greige carpet having a primary backing and tufted fibers, providing a secondary backing composed of a nonwoven textile of synthetic fibers, providing a thermoplastic adhesive composition including a modified PET having a crystallinity less than unmodified PET and a melting point from about 90° C. to about 150° C. and a particulate filler, and using the thermoplastic adhesive composition to adhere the greige carpet to the secondary backing to form a carpet product.

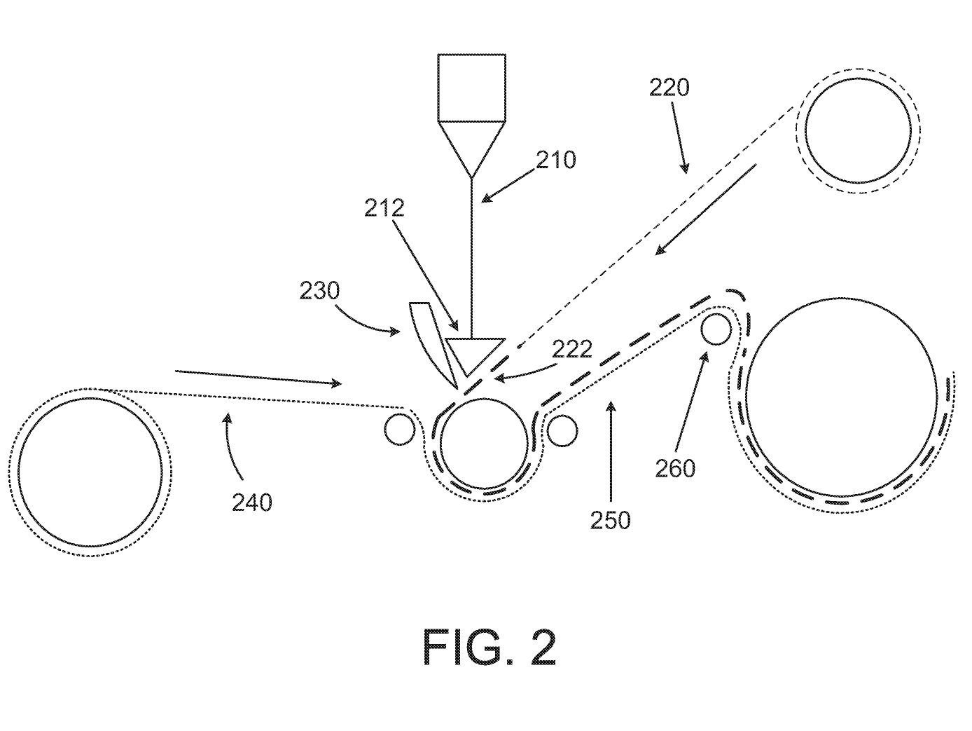

Methods of manufacturing lightweight carpet products may further include a process for using a thermoplastic adhesive composition to adhere greige carpet to secondary backing material, such as those described in U.S. Pat. No. 8,021,506 to Doney et al. In certain embodiments, a thermoplastic adhesive composition is dispersed onto a surface of a secondary backing to form an adhesive-loaded secondary backing and then a greige carpet is brought into contact with the adhesive-loaded secondary backing to adhere the greige carpet to the secondary backing. As shown in FIG. 2, for example, a thermoplastic adhesive composition 210 may be dispersed onto a surface of a secondary backing 220 to form an adhesive-loaded secondary backing 222, the adhesive-loaded secondary backing 222 may then be passed under a heated doctor bar 230, and a greige carpet 240 may then be contacted with the adhesive-loaded secondary backing 222 to form a carpet product 250. In certain embodiments, the thermoplastic adhesive composition may form a pool 212 on the surface of the secondary backing 220.

In certain embodiments, a nip pressure may be applied to the final carpet product with a press roll 260. The press roll may be spaced away from the carpet product at a gap distance sufficient to apply a light pressure to the carpet product. Applying light pressure to the lightweight carpet product was found to enhance the penetration of the thermoplastic adhesive composition into the greige carpet without damaging the tufted fibers. In one embodiment, a gap between the carpet product and the press roll is from about 185 mm to about 285 mm.

In certain embodiments, the secondary backing includes a spun laid nonwoven textile of polyester fibers. In certain embodiments, the secondary backing has a basis weight from about 2.5 ounces per square yard to about 6 ounces per square yard and has a porosity such that the thermoplastic adhesive composition will not substantially penetrate the secondary backing.

In certain embodiments, the particulate filler is present an from about 37 to about 41 percent by weight of the thermoplastic adhesive composition.

In certain embodiments, the final carpet product has a basis weight of less than 60 ounces per square yard. For example, the carpet product may have a basis weight from about 50 ounces per square yard to about 60 ounces per square yard. In certain embodiments, the carpet product is cut to form a plurality of carpet tiles.

In another aspect, a method of making a thermoplastic adhesive composition is provided. The method includes transesterifying raw PET with a monomer mix to produce modified PET and non-modified PET reaction products and removing at least a portion of the non-modified PET reaction products to produce a modified PET composition having a crystallinity less than unmodified PET and a melting point from about 90° C. to about 150° C.

Transesterification of PET with a monomer mix may be performed in accordance with U.S. Pat. No. 7,157,139 to Salsman et al. and/or U.S. Patent Application Publication No 2008/0236443 to Salsman. In certain embodiments, transesterification may be performed at a temperature from about 200° C. to about 270° C. In certain embodiments, the monomer mix comprises a glycol.

The removal of non-modified PET reaction products may be performed, for example, under vacuum. In certain embodiments, the portion of the non-modified PET reaction products removed is effective to give the modified PET composition a viscosity from about 11.5 poise to about 12 poise. In operation, relatively low viscosities may be achieved by reducing the cycle time of the transesterification reaction, for example.

Publications cited herein and the materials for which they are cited are specifically incorporated by reference. Modifications and variations of the methods and devices described herein will be obvious to those skilled in the art from the foregoing detailed description. Such modifications and variations are intended to come within the scope of the appended claims.

1. A carpet product comprising:
a greige carpet which comprises a primary backing and tufted fibers;
a secondary backing which comprises a nonwoven textile of synthetic fibers; and
a thermoplastic hot melt adhesive composition adhered to the greige carpet and the secondary backing, the thermoplastic adhesive composition having a viscosity from 5,000 centipoise at 325° F. to 10,000 centipoise at 325° F. and comprises:
a modified polyethylene terephthalate (PET) having a crystallinity less than unmodified PET and a melting point from about 90° C. to about 150° C.; and
a particulate filler in the amount from 37 to 41 percent by weight of the thermoplastic hot melt adhesive composition,
wherein the carpet product has a basis weight of less than 60 ounces per square yard.

2. (canceled)

3. The carpet product of claim 1, wherein the carpet product has a basis weight from about 50 ounces per square yard to about 60 ounces per square yard.

4. (canceled)

5. The carpet product of claim 1, wherein the thermoplastic adhesive composition has a viscosity from about 6,000 centipoise at 325° F. to about 8,500 centipoise at 325° F.

6. The carpet product of claim 1, wherein the modified PET has a melting point from about 100° C. to about 115° C.

7. The carpet product of claim 1, wherein the particulate filler is present in an amount less than 43 percent by weight of the thermoplastic adhesive composition.

8. The carpet product of claim 7, wherein the particulate filler has a specific heat from about 0.15 kcal/kg° C. to about 0.25 kcal/kg° C.

9. (canceled)

10. The carpet product of claim 1, wherein the particulate filler comprises glass, ceramic, barite, calcium carbonate, magnetite, stone, or a combination thereof.

11. The carpet product of claim 1, wherein the particulate filler has a particle size smaller than 60 mesh.

12. The carpet product of claim 1, wherein the particulate filler has a particle size from about 80 mesh to about 60 mesh.

13. The carpet product of claim 1, wherein the synthetic fibers comprise polyester fibers.

14. The carpet product of claim 13, wherein the secondary backing comprises a spunlaid nonwoven textile of polyester fibers.

15. The carpet product of claim 1, wherein the secondary backing has a basis weight of less than 6 ounces per square yard.

16. The carpet product of claim 1, wherein the secondary backing has a basis weight from about 2.5 ounces per square yard to about 6 ounces per square yard.

17. The carpet product of claim 1, wherein the secondary backing has a porosity such that the thermoplastic adhesive composition will not substantially penetrate through the secondary backing.

18. The carpet product of claim 1, wherein the carpet product is a carpet tile.

19. A carpet tile comprising:
a greige carpet which comprises a primary backing and tufted fibers;
a secondary backing which comprises a spunlaid nonwoven textile of polyester fibers; and
a thermoplastic adhesive composition adhered to the greige carpet and the secondary backing, the thermoplastic adhesive composition having a viscosity from 5,000 centipoise at 325° F. to 10,000 centipoise at 325° F. and comprises:
a modified polyethylene terephthalate (PET) having a crystallinity less than unmodified PET and a melting point from about 90° C. to about 150° C.; and
a glass particulate filler in an amount from about 37 to about 41 percent by weight of the thermoplastic adhesive composition,
wherein the carpet tile has a basis weight from about 50 ounces per square yard to about 60 ounces per square yard.

20. A method of making a carpet product comprising:
providing a thermoplastic adhesive composition which comprises:
modified PET having a crystallinity less than unmodified PET and a melting point from about 90° C. to about 150° C.; and
a particulate filler;
providing a greige carpet which comprises a primary backing and tufted fibers;
providing a secondary backing which comprises a nonwoven textile of synthetic fibers; and
using the thermoplastic adhesive composition to adhere the greige carpet to the secondary backing to form a carpet product.

21-35. (canceled)
